(19) United States
(12) Patent Application Publication
(10) Pub. No.: US 2021/0138503 A1
(43) Pub. Date: May 13, 2021

(54) Functional Termination of Parylene in Vacuum

(71) Applicant: HZO, Inc., Morrisville, NC (US)

(72) Inventors: Robert Askin, Cary, NC (US); Sean Clancy, Apex, NC (US)

(73) Assignee: HZO, Inc., Morrisville, NC (US)

(21) Appl. No.: 17/098,279

(22) Filed: Nov. 13, 2020

Related U.S. Application Data
(60) Provisional application No. 62/934,902, filed on Nov. 13, 2019.

(51) Int. Cl. B05D 1/00; B05D 7/00

(52) U.S. Cl. CPC B05D 1/60; B05D 7/5483

(57) ABSTRACT

A method includes adding a coating on a substrate, wherein the coating is a protective coating for the substrate and adding a chemistry to an outer portion or surface of the coating on the substrate. The chemistry is configured to better facilitate a creation of a chemical bond between the coating and a second layer to be applied to the coating.

### CROSS-REFERENCES TO RELATED APPLICATIONS

This application claims the benefit of U.S. Provisional Patent Application No. 62/934,902, filed Nov. 13, 2019, which is incorporated herein by reference in its entirety.

### FIELD

Embodiments of methods and apparatuses and systems are described for terminating Parylene. Some embodiments of methods and apparatuses and systems are described for terminating Parylene in a vacuum.

### BACKGROUND

The coating of components is common for a number of reasons. Some parts or components are coated for protection against ambient conditions. Parts are components may be coated to add a dielectric layer or simply to prolong a part that undergoes a lot of wear and tear. These coatings are applied by any number of methods. The coating of parts or components is often part of larger product or part manufacturing process where additional layers or molds are applied to the coated part or component. One problem with adding layers or overcoats to an already coated part is that the additional layer, mold, or covering may not adequately stick or adhere to the coating. This lack of good adhesion may cause delamination of the part at the point of the coating.

One way this problem is solved is by adding a process step where the coating is roughed up to improve adhesion to any additional layers added to the coated part. This is often done by some sort of mechanical of chemical etching and may include an additional oxidizing step. This solution is not without its setbacks. The additional step or steps to improve adhesion typically require a separate process with additional equipment and material costs and complexities. The additional step often requires removal of the part from the coating deposition process, which means the removal or break of the vacuum used for the vapor deposition coating process. This vacuum break introduces ambient air and moisture to the coating part which can contaminate the part or introduce impurities which may require removal before application of the additional layer or coat. This further complicates the process and introduces additional costs in terms of time and materials and equipment. The additional etching step also is a temporary fix in that the etching can rub off after a while are become ineffective after a relatively short exposure to ambient conditions.

What is needed is a process for increasing the adhesion properties of a coating without adding process steps using different devices or machinery. What is needed is a adhesion enhancement process that reduces the negative effect of ambient conditions on the coating. What is needed is a simplified process that can create lasting adhesion properties for a coated item. Such processes are described herein. In addition, systems that facilitate the processes are described herein.

### SUMMARY

The subject matter of the present application has been developed in response to the present state of the art, and in particular, in response to the problems and disadvantages associated with conventional systems that have not yet been fully solved by currently available techniques. Accordingly, the subject matter of the present application has been developed to provide embodiments that overcome at least some of the shortcomings of prior art techniques.

Disclosed herein is a method. The method includes adding a coating on a substrate, wherein the coating is a protective coating for the substrate and adding a chemistry to an outer portion or surface of the coating on the substrate. The chemistry is configured to better facilitate a creation of a chemical bond between the coating and a second layer to be applied to the coating. The preceding subject matter of this paragraph characterizes example 1 of the present disclosure.

The coating is a Parylene coating. The preceding subject matter of this paragraph characterizes example 2 of the present disclosure, wherein example 2 also includes the subject matter according to example 1, above.

Adding the chemistry to the outer portion or surface of the coating on the substrate comprises modifying a molecular chain of the coating. The preceding subject matter of this paragraph characterizes example 3 of the present disclosure, wherein example 3 also includes the subject matter according to any one of examples 1-2, above.

Adding the chemistry to the outer portion or surface of the coating on the substrate comprises changing an outer surface chemistry of the coating due to changes in a termination species of the coating. The preceding subject matter of this paragraph characterizes example 4 of the present disclosure, wherein example 4 also includes the subject matter according to any one of examples 1-3, above.

The coating is a polymer. The preceding subject matter of this paragraph characterizes example 5 of the present disclosure, wherein example 5 also includes the subject matter according to any one of examples 1-4, above.

Adding the chemistry to the outer portion or surface of the coating on the substrate comprises adding a functional end group on the polymer, wherein the functional end group is more reactive to the second layer. The preceding subject matter of this paragraph characterizes example 6 of the present disclosure, wherein example 6 also includes the subject matter according to any one of examples 1-5, above.

The method comprises adding the second layer to a portion of the coating. The preceding subject matter of this paragraph characterizes example 7 of the present disclosure, wherein example 7 also includes the subject matter according to any one of examples 1-6, above.

The method further includes exposing the coating or coating surface to an adhesion promoter. The preceding subject matter of this paragraph characterizes example 8 of the present disclosure, wherein example 8 also includes the subject matter according to any one of examples 1-7, above.

The adhesion promoter is a bifunctional compound. The preceding subject matter of this paragraph characterizes example 9 of the present disclosure, wherein example 9 also includes the subject matter according to any one of examples 1-8, above.

The bifunctional compound is configured to react chemically to a second layer to be applied on the coating. The preceding subject matter of this paragraph characterizes example 10 of the present disclosure, wherein example 10 also includes the subject matter according to any one of examples 1-9, above.

The bifunctional compound is configured to form a chemical bond or bridge between the coating and the second layer. The preceding subject matter of this paragraph characterizes example 11 of the present disclosure, wherein example 11 also includes the subject matter according to any one of examples 1-10, above.

The bond is a covalent bond between the coating and the second layer. The preceding subject matter of this paragraph characterizes example 12 of the present disclosure, wherein example 12 also includes the subject matter according to any one of examples 1-11, above.

The adhesion promoter is configured to add a silyl functional group to a polymer structure of the coating. The preceding subject matter of this paragraph characterizes example 13 of the present disclosure, wherein example 13 also includes the subject matter according to any one of examples 1-12, above.

The adhesion promoter comprises a hydrolysable functional group. The preceding subject matter of this paragraph characterizes example 14 of the present disclosure, wherein example 14 also includes the subject matter according to any one of examples 1-13, above.

Disclosed herein is a method. The method includes adding a coating on a substrate, wherein the coating is a protective coating for the substrate and adding a chemistry to an outer portion or surface of the coating on the substrate. The chemistry is configured to better facilitate a creation of a chemical bond between the coating and a second layer to be applied to the coating. The method includes adding the second layer to the coating. The preceding subject matter of this paragraph characterizes example 15 of the present disclosure.

The coating is a Parylene coating and adding the chemistry to the outer portion or surface of the coating on the substrate comprises changing an outer surface chemistry of the coating due to changes in a termination species of the coating. The preceding subject matter of this paragraph characterizes example 16 of the present disclosure, wherein example 16 also includes the subject matter according to example 15, above.

The coating is a polymer and wherein adding the chemistry to the outer portion or surface of the coating on the substrate comprises adding a functional end group on the polymer, wherein the functional end group is more reactive to the second layer. The preceding subject matter of this paragraph characterizes example 17 of the present disclosure, wherein example 17 also includes the subject matter according to any one of examples 15-16, above.

The method further includes exposing the coating or coating surface to an adhesion promoter, wherein the adhesion promoter is a bifunctional compound, and wherein the bifunctional compound is configured to react chemically to a second layer to be applied on the coating. The preceding subject matter of this paragraph characterizes example 18 of the present disclosure, wherein example 18 also includes the subject matter according to any one of examples 15-17, above.

The adhesion promoter is configured to add a silyl functional group to a polymer structure of the coating. The preceding subject matter of this paragraph characterizes example 19 of the present disclosure, wherein example 19 also includes the subject matter according to any one of examples 15-18, above.

The adhesion promoter comprises a hydrolysable functional group. The preceding subject matter of this paragraph characterizes example 20 of the present disclosure, wherein example 20 also includes the subject matter according to any one of examples 15-19, above.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts a flow chart diagram of a method for implementation with systems in accordance with one or more embodiments of the present invention;

FIG. 2 depicts a flow chart diagram of a method for implementation with systems in accordance with one or more embodiments of the present invention;

FIG. 3 depicts an apparatus with an added chemistry on the outer portion of a coating in accordance with one or more embodiments of the present invention; and

FIG. 4 depicts an apparatus with a second layer on top of a coating in accordance with one or more embodiments of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

In some embodiments, the term “coating”, used herein as a noun includes and is interchangeable with the terms, “treatment”, “residue”, “film”, “lamination”, “layer”, “veneer”, “plating”, “overlay”, and any other application of one substance or material to another. A “coating” may be made of organic and inorganic materials and specifically includes polymers and other protective coatings. In some embodiments, the term “coating” may refer to a Parylene coating.

The expression “configured to” as used herein may be used interchangeably with “suitable for,” “having the capacity to,” “designed to,” “adapted to,” “made to,” or “capable of” according to a context. The term “configured” does not necessarily mean “specifically designed to” in a hardware level. Instead, the expression “apparatus configured to . . . ” may mean that the apparatus is “capable of . . . ” along with other devices or parts in a certain context.

The term “selectively coating” or “selectively coated” as used herein throughout with regard to a part, component, device, and the like, means completely or partially coating the part, component, device, and the like. This term also includes completely or partially coating the part, component, device, and the like, and then removing at least a portion of the coating. Additionally, items subjected to a “selective coating” or that have been “selectively coated” have a “selective coating” or a “selective coat.” Furthermore, the term “selective coating” has a similar meaning and can similarly be used as a noun or a verb. For purposes of clarification only, a part, component, device, and the like that has been completely or partially coated, and then had at least some of that coating modified through a chemical process or other process has a “selective coat”, has been “selectively coated”, or has been through the process of “selective coating.”

The terms “part”, “component”, “device”, or “item” may be used interchangeably. These terms are meant to include substrates, printed circuit boards and any other item that is or can be coated.

While many embodiments are described herein, at least some of the described embodiments facilitate improved application of an additional layer to a coating on a substrate. One example of a use case for embodiments of the present invention includes printed circuit boards for electronic devices. These are coated with a polymer or other protective coating. One class of coating material that has proven well suited to chemical vapor deposition on a part such as a printed circuit board is Parylene. Parylene offers good waterproof and other protection qualities. But printed circuit boards, like many coated parts, some portions made need additional layers on top of the coating.

In one embodiment of the present invention, improved adhesion qualities of a coating or coating material are accomplished by adding a chemistry to an outer portion or surface of the coating, which better facilitates the creation of a chemical bond between the coating and the layer to be applied to the coating. In one embodiment this is accomplished by modifying the molecular chain of the coating. Stated another way, the coating may be textured by changing the outer surface chemistry of the coating material due to changes in the termination species of the coating. In one embodiment where the coating is a polymer, the addition of a chemistry or chemical process, creates a functional end group on the polymer that is more reactive to an additional layer than it may otherwise be without the functional end group or termination species. Thus, at least a portion of the coating is modified to better react with a layer to be added, thus chemically bonding the coating to the added layer. In one embodiment, the coating is enhanced to create a covalent bond between elements of the coating and elements of the applied layer.

The adhesion enhancing surface chemistry may be applied to the coating or coating surface by exposing the coating or coating surface to an adhesion promoter. The adhesion promoter may be a bifunctional compound that can react chemically to a desired layer to be applied and form a chemical bond or bridge between the coating and the layer. The adhesion promoter may allow the bonding of one of an organic or inorganic coating to one of an organic or inorganic layer. In one embodiment, the adhesion promoter acts as the interface to chemically and physically bond dissimilar materials into a strong cohesive bond structure.

In one embodiment the adhesion promoter is configured to add a silyl functional group to the polymer structure of the coating. The adhesion promoter may be a silane or organosilane that provides a surface chemistry to the coating giving at least a portion of the coating siliceous properties. In another embodiment, the adhesion promoter includes one or more of silicates, aluminates, borates, and the like. In yet another embodiment, the adhesion promoter is configured with a hydrolysable functional group, or configured to create a hydrolysable functional group, in the chemical makeup of the coating. The adhesion promoter may be configured with an alkoxy, acyloxy, halogen or amine group, or be configured to create an alkoxy, acyloxy, halogen or amine group, in the coating. In one embodiment, hydrolysis forms a reactive silanol group (SiOH) on the surface of the coating, which can condense with other silanol groups, for example, those on the surface of siliceous fillers, to form siloxane linkages between the coating and a layer. In some embodiments, the adhesion promotor may create end groups on the polymer chain of the coating that can form stable products or bonds with other oxides found on the surface of a layer, such as oxides of aluminum, zirconium, tin, titanium, and nickel.

The adhesion promoter may create a radical group (R group) within the coating. The radical group facilitates, or provides a site for, bonding with the layer. In one embodiment, the adhesion promoter treatment is a Silane treatment that forms radicals on the surface of a Parylene coating to which a desired layer can bond. The adhesion promoter may create a radical group that possesses a functionality that creates desired characteristics in a bond between the coating and the layer. Accordingly, embodiments of the present invention allow a coating to be customizable to create bonding or adhesion properties that are specific to a layer that is desired to be attached or bonded to the coating. For example, the adhesion promoter may be applied to a coating to produce an R group in the coating polymer chain that is a nonhydrolyzable organic radical. In another example, the adhesion promoter may create an R group in the coating that can react with a layer and utilize the layer to catalyze a chemical transformation at the interface of the coating and the layer which may order an interfacial region or modify the bonding or adhesion characteristics between the coating and layer. The adhesion promoter may be chosen to create end groups or functional groups that have the ability to effect a covalent bond between the coating and a layer with specific characteristics.

The adhesion promotor may be a Silane that can modify the surface of a coating under anhydrous conditions consistent with monolayer and vapor phase deposition chambers. In one embodiment the Silane is an alkoxysilane. In another embodiment the Silane is a methoxysilane. It will be appreciated that some adhesion promoters chemically transform or alter the surface of a coating with the use of an additional catalyst. In other embodiment, adhesion promoters may chemically transform or alter the surface of a coating using the chemical composition of the layer as a catalyst. In yet other embodiments, the chemical reaction on the surface of the coating is accomplished without a catalyst.

The adhesion promoter may be applied to the coating or coated material by means of vapor deposition. In this embodiment, the adhesion promoter used may be a cyclic azasilane. The Silane adhesion promoter may be vinyl trichlorosilane in either xylene, isopropanyl alcohol, or Freon, and gamma-methacryloxypropyltrimethoxy silane. The adhesion promoter may be used with a solvent. In one embodiment the adhesion promoter is used with a methanol-water solvent. In some embodiments, the Silane is one or more Silanes selected from the group consisting of Silquest® A-174, Silquest® 111 and Silquest® A-174 (NT).

In one embodiment, the adhesion promoter may include molecules found in the layer to be added to the coating. In these embodiments, the surface of the coating may be chemically altered to include similar molecules to those on a surface of the layer to promote attraction and better molecular bonding between the coating and the layer. For example, the layer to be attached to the coating may be a nylon, a vinyl, a butyl, an acrylate, a methacrylate, and the like. Thus, an adhesion promoter such as vinylsilane may be used to create the desired coating surface chemistry to react with a vinyl layer. Other silanized chemistries may be used to alter the surface of coating to achieve desired adhesion with a particular layer. In one embodiment, the adhesion promoter may utilize a monomer surface chemistry. In another embodiment, the adhesion promoter may utilize a polymer chemistry.

It will be appreciated that an adhesion promoter may be chosen by matching the organic functionality of the adhesion promoter to the base polymer of the coating to optimize bonding with a particular layer. In certain embodiments, a mixture of adhesion promoters are used to provide enhanced hydrophobicity, thermal stability, or crosslinking at the bonding site between the coating and the layer. Thus one or more processes of the present invention can be customized to bond specific coatings to specific layers by using adhesion promoters to alter the surface chemistry of the coating in a specific way.

A process of applying an adhesion promoter to a coating or coated item to affect desired coating surface chemistries may further include contacting the coating or coated item with the adhesion promoter in gaseous form. A process of applying an adhesion promoter to a coating or coated item to affect desired coating surface chemistries may include vaporizing the adhesion promoter by heating it to its evaporation point to form a gas. For example, where the adhesion promoter is a silane, the silane may be vaporized by heat the silane to form gaseous silane. The vaporization of the adhesion promoter may be done in stages. In some embodiments, the vaporization of the adhesion promoter is done by heating in 2 stages, 3 stages, 4 stages, or more than 4 stages. In another embodiment, the adhesion promoter may be vaporized in a 50:50 solution with water. In yet other embodiments, the adhesion promoter may be vaporized at 80 degrees C. for about 2 hours.

In one embodiment, the adhesion promoter may be placed in a crucible and the crucible inserted into a T′ thermocouple or onto a hot plate in a chamber or container with the coating or coated item to be treated. The amount of adhesion promoter poured into the crucible may depend on the number and size of coated objects in the chamber. In various embodiments, the amount of adhesion promoter vaporized may range from about 10 ml to about 100 ml, or in some cases more. In other embodiments, other methods may be used to heat the adhesion promotor to its evaporation point, as will be well-known to those of ordinary skill in the art. In another embodiment, a mixture of adhesion promoter with distilled water may be vaporized. In one embodiment, a 50/50 mix of adhesion promoter and distilled water is heated until the adhesion promoter is vaporized. In one specific embodiment, the adhesion promoter is silane, which is vaporized by heating it at about 80 degrees C. for up to about 2 hours.

The process of adding the chemistry to modify the polymer chain of the coating may be accomplished using an adhesion promoter canister. The canister may be sealed capsule or container with a valve through which the adhesion promoter may be added. In one embodiment, the canister is heated and then opened up to allow exposure of the adhesion promoter to the coating. In one embodiment the exposure of the adhesion promoter is done after the deposition process of applying the coating to an item. In other embodiment, the adhesion promoter is exposed to the coating as part of, or during a certain step of the coating deposition process.

In one embodiment, the coating surface chemistry may be accomplished in the same chamber where the coating was applied to an item. In embodiments, where a coating is applied to an item by vapor deposition utilizing a chamber with a vacuum, the adhesion promotor may be applied to the coating without breaking the vacuum of the vapor deposition process. In certain embodiment this may be desirable because the vacuum may minimize contamination of, or impurities that may settle on, the coating due to ambient air or moisture being allowed to settle on the freshly applied coating in the absence of the vacuum.

In one embodiment, the chamber is cleared after the vapor deposition coating process and before the application of the adhesion promoter. In certain embodiments the adhesion promoter is applied immediately after the vapor deposition coating process. In other embodiments, the adhesion promoter application step is initiated up to 120 minutes after the vapor deposition coating step is completed.

In one embodiment, the gaseous adhesion promoter may be exposed to a coating surface for between about 4 hours and about 12 hours. In another embodiment, the adhesion promoter is applied to the coating at a temperature of between about 50° C. and about 120° C.

In one particular embodiment, Parylene is applied to an item by vapor deposition. Without breaking the vacuum of the vapor deposition process, an adhesion promoter is applied to the chamber to cause a chemistry on the surface of the coating to create a functional group or end chain to ultimately facilitate the creation of a chemical bond between the coating and layer to be applied to the coating.

The processes of the present invention allow the adhesion promoter to be applied to the surface of a coating within the same vapor deposition chamber where the coating was applied to an item. This simplifies the manufacturing process saving time, money and materials. Further, because the processes of the present invention apply an adhesion promoter to a coating or coated item without breaking the vacuum of the deposition process, the manufacturing process is faster, more controlled, and more reliable. It will be appreciated that once the vacuum is broken, you have to deal with the effects of ambient air and moisture before applying a layer. This may include cleaning the coating, before applying the layer, which may reverse any adhesion properties your created. It further makes for a less consistent process and creates a process with increased variables. The processes of the present invention allow for custom coating and the creation of a chemical bond that is less likely to be worn off than traditional post coating etching or oxidation processes. Additionally, the processes of the present invention overcome the problem of time sensitivity with etching and other processes where there is only a short time in which to apply the layer before air and moisture cause these processes to lose some functionality.

It will be appreciated that the adhesive enhancement process may be applied to single-layered coatings or multi-layered coatings.

Referring now to FIG. 1, a flow chart diagram of a method 100 is shown. Although the method 100 is described in conjunction with the system described herein, embodiments of the method 100 may be implemented with other types of systems.

At block 101 the method includes adding a coating on a substrate, wherein the coating is a protective coating for the substrate. At block 104, the method includes adding a chemistry to an outer portion or surface of the coating on the substrate. At block 106, the chemistry is configured to better facilitate a creation of a chemical bond between the coating and a second layer to be applied to the coating.

In some embodiments, the coating is a Parylene coating.

In some embodiments, adding the chemistry to the outer portion or surface of the coating on the substrate comprises modifying a molecular chain of the coating.

in some embodiments, adding the chemistry to the outer portion or surface of the coating on the substrate comprises changing an outer surface chemistry of the coating due to changes in a termination species of the coating.

In some embodiments, the coating is a polymer. In some embodiments, adding the chemistry to the outer portion or surface of the coating on the substrate comprises adding a functional end group on the polymer, wherein the functional end group is more reactive to the second layer.

In some embodiments, the method comprises adding the second layer to a portion of the coating.

In some embodiments, the method further includes exposing the coating or coating surface to an adhesion promoter. In some embodiments. the adhesion promoter is a bifunctional compound. In some embodiments, the bifunctional compound is configured to react chemically to a second layer to be applied on the coating. In some embodiments, the bifunctional compound is configured to form a chemical bond or bridge between the coating and the second layer. In some embodiments, the bond is a covalent bond between the coating and the second layer.

In some embodiments, the adhesion promoter is configured to add a silyl functional group to a polymer structure of the coating.

In some embodiments, the adhesion promoter comprises a hydrolysable functional group.

Referring now to FIG. 2, a flow chart diagram of a method 200 is shown. Although the method 200 is described in conjunction with the system described herein, embodiments of the method 200 may be implemented with other types of systems.

At block 202, the method includes adding a coating on a substrate, wherein the coating is a protective coating for the substrate. At block 204, the method includes adding a chemistry to an outer portion or surface of the coating on the substrate. The chemistry is configured to better facilitate a creation of a chemical bond between the coating and a second layer to be applied to the coating. At block 206, the method includes adding the second layer to the coating.

In some embodiments, the coating is a Parylene coating and wherein adding the chemistry to the outer portion or surface of the coating on the substrate comprises changing an outer surface chemistry of the coating due to changes in a termination species of the coating.

In some embodiments, the coating is a polymer and wherein adding the chemistry to the outer portion or surface of the coating on the substrate comprises adding a functional end group on the polymer, wherein the functional end group is more reactive to the second layer.

In some embodiments, the method further includes exposing the coating or coating surface to an adhesion promoter, wherein the adhesion promoter is a bifunctional compound, and wherein the bifunctional compound is configured to react chemically to a second layer to be applied on the coating.

In some embodiments, the adhesion promoter is configured to add a silyl functional group to a polymer structure of the coating.

In some embodiments, the adhesion promoter comprises a hydrolysable functional group.

Referring now to FIG. 3, a substrate 302 with a protective coating 304 is shown. The coating may be a polymer coating, in some embodiments. In some embodiments, the coating is a Parylene coating. The polymer or Parylene coating may be applied on the substrate 302 in a manner consistent with known processes. The coating 304 has an added chemistry at an outer portion or surface 306 of the coating 304. The added chemistry may include any of the chemistries disclosed herein or obvious variants. The added chemistry may occur during the termination of the deposition of the coating 304 or in a separate process. The separate process may occur in the same chamber where the deposition of the coating 304 occurs. The separate process may occur without breaking vacuum of the chamber.

Referring now to FIG. 4, a substrate 302 with a protective coating 304 is shown. After the coating 304 has been modified at an outer portion or surface 306 of the coating 304, a second layer 308 is added. The added chemistry at an outer portion or surface 306 of the coating 304 may be selected or associated with the second layer 308. The selection of the particular added chemistry may he based on what the material of the second layer 308 will he to better facilitate the creation of a chemical bond between the coating 304 and the second layer 308 to be applied to the coating.

Although the foregoing disclosure provides many specifics, these should not be construed as limiting the scope of any of the ensuing claims. Other embodiments may be devised which do not depart from the scopes of the claims. Features from different embodiments may be employed in combination. The scope of each claim is, therefore, indicated and limited only by its plain language and the full scope of available legal equivalents to its elements.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The present subject matter may be embodied in other specific forms without departing from its spirit or essential characteristics. The described embodiments are to be considered in all respects only as illustrative and not restrictive.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity

What is claimed is:

1. A method comprising:
adding a coating on a substrate, wherein the coating is a protective coating for the substrate; and
adding a chemistry to an outer portion or surface of the coating on the substrate;
wherein the chemistry is configured to better facilitate a creation of a chemical bond between the coating and a second layer to be applied to the coating.

2. The method of claim 1, wherein the coating is a Parylene coating.

3. The method of claim 2, wherein adding the chemistry to the outer portion or surface of the coating on the substrate comprises modifying a molecular chain of the coating.

4. The method of claim 2, wherein adding the chemistry to the outer portion or surface of the coating on the substrate comprises changing an outer surface chemistry of the coating due to changes in a termination species of the coating.

5. The method of claim 1, wherein the coating is a polymer.

6. The method of claim 5, wherein adding the chemistry to the outer portion or surface of the coating on the substrate comprises adding a functional end group on the polymer, wherein the functional end group is more reactive to the second layer.

7. The method of claim 6, wherein the method comprises adding the second layer to a portion of the coating.

8. The method of claim 1, wherein the method further includes exposing the coating or coating surface to an adhesion promoter.

9. The method of claim 8, wherein the adhesion promoter is a bifunctional compound.

10. The method of claim 9, wherein the bifunctional compound is configured to react chemically to a second layer to be applied on the coating.

11. The method of claim 10, wherein the bifunctional compound is configured to form a chemical bond or bridge between the coating and the second layer.

12. The method of claim 11, wherein the bond is a covalent bond between the coating and the second layer.

13. The method of claim 8, wherein the adhesion promoter is configured to add a silyl functional group to a polymer structure of the coating.

14. The method of claim 8, wherein the adhesion promoter comprises a hydrolysable functional group.

15. A method comprising:
adding a coating on a substrate, wherein the coating is a protective coating for the substrate; and
adding a chemistry to an outer portion or surface of the coating on the substrate;
wherein the chemistry is configured to better facilitate a creation of a chemical bond between the coating and a second layer to be applied to the coating; and
adding the second layer to the coating.

16. The method of claim 15, wherein the coating is a Parylene coating and wherein adding the chemistry to the outer portion or surface of the coating on the substrate comprises changing an outer surface chemistry of the coating due to changes in a termination species of the coating.

17. The method of claim 15, wherein the coating is a polymer and wherein adding the chemistry to the outer portion or surface of the coating on the substrate comprises adding a functional end group on the polymer, wherein the functional end group is more reactive to the second layer.

18. The method of claim 17, wherein the method further includes exposing the coating or coating surface to an adhesion promoter, wherein the adhesion promoter is a bifunctional compound, and wherein the bifunctional compound is configured to react chemically to a second layer to be applied on the coating, wherein the adhesion promoter comprises either a silyl functional group or a hydrolysable functional group.

19. The method of claim 18, wherein the adhesion promoter is configured to add a silyl functional group to a polymer structure of the coating.

20. The method of claim 18, wherein the adhesion promoter comprises a hydrolysable functional group.
